(19) United States
(12) Patent Application Publication
(10) Pub. No.: US 2022/0156798 A1
(43) Pub. Date: May 19, 2022

(54) METHOD, DEVICE, STORAGE MEDIUM AND TERMINAL FOR PUSHING ADVERTISEMENT

(71) Applicant: SHENZHEN JOYBOT LIMITED, Shenzhen (CN)

(72) Inventors: Hui Wu, Shenzhen (CN); ALLEN YI ZHANG, Shenzhen (CN)

(73) Assignee: SHENZHEN JOYBOT LIMITED, Shenzhen (CN)

(21) Appl. No.: 17/160,491

(22) Filed: Jan. 28, 2021

(30) Foreign Application Priority Data
Nov. 16, 2020 (CN) 202011282558.5

(51) Int. Cl. G06Q 30/02; G06F 16/903; G06K 9/00; G06K 9/62; G06T 7/70

(52) U.S. Cl. CPC G06Q 30/0276; G06Q 30/0246; G06F 16/90335; G06T 2207/10016; G06K 9/6201; G06T 7/70; G06K 9/00718

(57) ABSTRACT

A method, a device, a storage medium and a terminal for pushing advertisement. The method includes: during a video playing process, determining an object picture in a frame of the video; matching the object picture with a corresponding advertised commodity picture in an advertisement database and then generating a corresponding object advertisement data based on the advertised commodity picture, or recognizing an object name based on the object picture, then obtaining a corresponding object advertisement data according to the object name; and pushing the object advertisement data to the terminal. When the server pushes the advertisement data corresponding to the object, the user can directly access the object's commodity page through the object advertisement data, and it is no longer necessary for the user to search on the official website or third-party service platform to access the object's commodity page, improving the accuracy of advertising and the user experience.

### CROSS-REFERENCE TO RELATED APPLICATIONS

This disclosure claims priority to CN Patent Application No.202011282558.5, filed on Nov. 16, 2020, which, as a whole, is incorporated herein by reference.

### TECHNICAL FIELD

This disclosure relates to a computer science field, in particular a method, a device, a storage medium and a terminal for pushing advertisement.

### BACKGROUND

With the development of Internet, smart devices are increasingly used in people's daily lives, and the user groups of smart devices range from children to the elderly. In current relevant technologies, when the user watches a video on a smart device, the advertisement information of related objects in the frame of the video will be pushed onto the video playing interface. If the user is interested in related objects, the user needs to search and query the purchase links of these objects by himself, but this will cause users to be unable to accurately :ad these objects, and also affect the user experience.

### SUMMARY

The embodiments of the present disclosure provide a method, a device, a non-transitory storage medium, and a terminal for pushing advertisement, and aim to solve the technical problem of how to accurately push advertised commodity. The technical solutions are provided as follows:

In a first aspect, some embodiments of the present disclosure provide an advertisement pushing method, and the method comprises: during a video playing process, determining an object picture in a frame of the video; matching the object picture with an corresponding advertised commodity picture in an advertisement database; generating a corresponding object advertisement data based on the advertised commodity picture or recognizing an object name based on the object picture, then obtaining a corresponding object advertisement data according to the object name; and finally, pushing the object advertisement data to the terminal.

Optionally, said ‘determining an object picture in a frame of the video’ comprises: obtaining a template picture; searching tot a targeting position of the template picture in the frame of the video according to the template picture; and generating the object picture according to a screenshot of the targeting position of the template picture,

Optionally, before said ‘obtaining a template picture’, the method further comprises: receiving an advertisement click information from the terminal, wherein the advertisement click information includes the number and type of clicks on the commodity by a user within a preset time period; and determining the template picture according to the advertisement click information.

Optionally, said generating corresponding object advertisement data based on the advertisement object picture includes: querying a purchase link information corresponding to the advertised commodity picture in the advertisement database, and generating a corresponding object advertisement data according to the object picture and the purchase link information and/or querying a purchase link information corresponding to the advertised commodity picture in a third-party service platform, and generating a corresponding object advertisement data according to the object picture and the purchase link information.

Optionally, said ‘generating a corresponding object advertisement data based on the advertised commodity picture’ comprises: querying a purchase link information corresponding to the advertised commodity picture in the advertisement database, and generating a corresponding object advertisement data according to the advertised commodity picture and the purchase link information; and/or querying a purchase link information corresponding to the advertised commodity picture in a third-party service platform, and generating a corresponding object advertisement data according to the advertised commodity picture and the purchase link information.

Optionally, said ‘pushing the object advertisement data to the terminal’ comprises: determining an advertisement display position corresponding to the object advertisement data in a video playing interface; and pushing the object advertisement data to the terminal based on the advertisement display position.

Optionally, the advertisement display position is a preset advertisement column position in the video playing interface; and/or the advertisement display position determined by a display position of the object in the frame of the video.

Optionally, the object advertisement data comprises the object picture and an object graphic code; or the object advertisement data comprises the advertised commodity picture and an object graphic code; wherein the object graphic code is used to access a commodity page of the object picture on the terminal.

In a second aspect, some embodiments of the present disclosure provide an advertisement pushing device, and the device comprises: an object determination module configured to determine an object picture in a frame of the video during a video playing process; an object matching module configured to match the object picture with a corresponding advertised commodity picture in an advertisement database; an object advertisement generating module configured to generate a corresponding object advertisement data based on the advertised commodity picture, or an object advertisement obtaining module configured to recognize an object name based on the object picture, and to obtain corresponding object advertisement data according to the object name; and an abject advertisement pushing module configured to push the object advertisement data to a terminal.

In a third aspect, some embodiments of the present disclosure provide a non-transitory storage medium, wherein the non-transitory storage medium stores a plurality of instructions suitable for being loaded by a processor and executing the above methods.

In a fourth aspect, some embodiments of the present disclosure provide a terminal, comprising a processor and a non-transitory memory; wherein the non-transitory memory stores a computer program suitable for being loaded by the processor and executing the above methods.

The beneficial effects brought by technical solutions according to embodiments of the present disclosure comprise at least the following:

When the embodiments of the present disclosure are executed, a server would determine an object picture in a frame of the video during a video process; match the object picture with a corresponding advertised commodity picture in an advertisement database and then generate a corresponding object advertisement data based on the advertised commodity picture, or recognize an object name based on the object picture, then obtain a corresponding object advertisement data according to the object name; and push the object advertisement data to the terminal. According to methods of this disclosure, when the server pushes the object advertisement data corresponding to the object, the user can directly access the object's commodity page through the object advertisement data, and it is no longer necessary for the user to search on the official website or third-party service platform to access the object's commodity page, improving the accuracy of advertising and the user experience.

### BRIEF DESCRIPTION OF THE DRAWINGS

In order to explain embodiments of the present disclosure or technical solutions in the prior art more clearly, the drawings that need to be used in the description of the embodiments or the prior art will be briefly introduced below. Obviously, the drawings described below are only some embodiments of the present disclosure. For those skilled in the art, other drawings can be obtained based on these drawings without creative work.

FIG. 1 is a schematic diagram of the system architecture of an advertisement pushing method according to an embodiment of the present disclosure;

FIG. 2 is a schematic flowchart of an advertisement pushing method according to an embodiment of the present disclosure;

FIG. 3 is a schematic flowchart of an advertisement pushing method according to an embodiment of the present disclosure;

FIG. 4 is a schematic flowchart of an advertisement pushing method according to an embodiment of the present disclosure;

FIG. 5 is a schematic diagram of a display interface of an advertisement pushing method according to an embodiment of the present disclosure;

FIG. 6 is a schematic diagram of a display interface of an advertisement pushing method according to an embodiment of the present disclosure;

FIG. 7 is a schematic diagram of a display interface of an advertisement pushing method according to an embodiment of the present disclosure;

FIG. 8 is a schematic diagram of a display interface of an advertisement pushing method according to an embodiment of the present disclosure;

FIG. 9 is a schematic flowchart of an advertisement pushing method according to embodiment of the present disclosure;

FIG. 10 is a schematic structural diagram of an advertisement pushing device according to an embodiment of the present disclosure;

FIG. 11 is a schematic structural diagram of a terminal (server) according to an embodiment of the present disclosure.

### DETAILED DESCRIPTION OF THE INVENTION

In order to make the purposes, features, and advantages of embodiments of the present disclosure more obvious and understandable, the technical solutions in the embodiments of the present disclosure will be described clearly and completely in conjunction with the figures in the embodiments of the present disclosure. Obviously, the described embodiments are only a part of embodiments of the present disclosure, but not all the embodiments. Based on the embodiments in this disclosure, all other embodiments obtained by those skilled in the art without creative work shall fall within the protection scope of this disclosure.

When referring to the figures in the context, unless otherwise indicated, the same numbers in different drawings represent the same or similar elements. The implementations described in the following exemplary embodiments do not represent all the implementations consistent with the present disclosure. On the contrary, they are merely examples of devices and methods consistent with some aspects of the present disclosure as detailed in the appended claims.

In the context of this disclosure, it should be understood that the terms ‘first’, ‘second’, etc. are only used for descriptive purposes, and cannot be understood as indicating or implying relative importance. For those skilled in the art, the specific meanings of the aforementioned terms in this disclosure can be understood under specific circumstances.

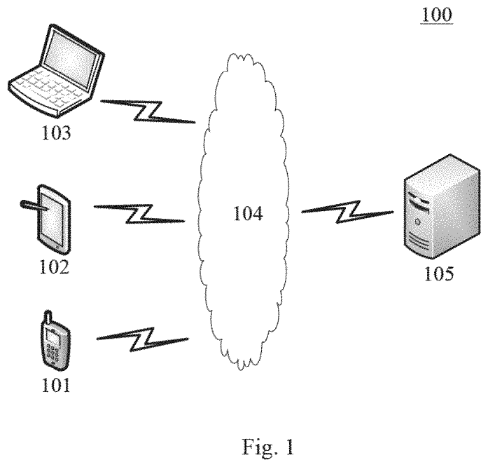

FIG. 1 shows a schematic diagram of an exemplary system architecture 100, which could realize advertisement pushing methods or advertisement pushing devices according to embodiments of the present disclosure.

As shown in FIG. 1, the system architecture 100 may include one or more of terminals 101, 102, 103, a network 104 and a server 105. The network 104 is used to provide a medium for communication links between the terminals 101, 102, 103 and the server 105. The network 104 may include various connection types, such as wired, wireless communication links, or fiber optic cables.

It should be understood that the numbers of terminals, networks, and servers in FIG. 1 are merely illustrative. According to actual needs, there can be any number of terminals, networks and servers. For example, the server 105 may be a server cluster consisted of multiple servers.

The user can use the terminals 101, 107, and 103 to interact with the server 105 through the network 104 to receive or send messages and so on. The terminals 101, 102, 103 may be various electronic devices with display screens, including but not limited to small phones, tablet computers, portable computers, desktop computers, televisions, and so on.

The terminals 101, 102, 103 in this disclosure may be terminals that provide various services. For example, during a video playing process, the server 105 would determine an object picture in a frame of the video; match the object picture with a corresponding advertised commodity picture in an advertisement database and then generate a corresponding object advertisement data based on the advertised commodity picture, or recognize an object name based on the object picture, and then obtain a corresponding object advertisement data according to the object name; and push the object advertisement data to the terminal.

It should be noted that the advertisement pushing methods according to embodiments of the present disclosure can be executed by one or more of the terminals 101, 102, 103, and/or the server 105. Accordingly, the advertisement pushing devices in embodiments of the present disclosure are generally set in corresponding terminals, and/or in the server 105, but the disclosure is not limited to this.

In the following embodiments on methods, for ease of description, the execution subject of each step is only depicted as a server for introduction and description.

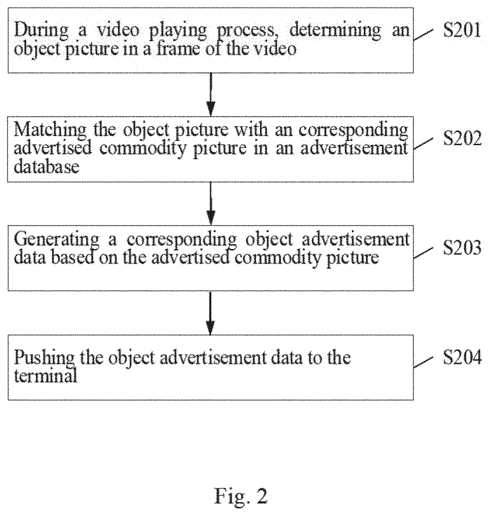

FIG. 2 is a schematic flowchart of an advertisement pushing method according to an embodiment of this disclosure. As shown in FIG. 2, the method of the embodiment of the present disclosure may include the following steps:

S201: during a video playing process, determining the object picture in the frame of the video.

It is understandable that a video consists of a plurality of pictures, and each picture can contain various objects. When the video is recognized, the pictures can be recognized through image recognition technology to obtain recognition results. The recognition results include various objects, such as: bags, glasses, clothes, hats, skin care products, cosmetics, microphones, etc. Based on the position of each object in the picture, a screens of can be taken to generate object pictures in which objects are showed.

It is understandable that the video may be a TV drama type video, a variety show type video, an advertisement type video, and other types of videos, and so on.

S202: matching the object picture with a corresponding advertised commodity picture in an advertisement database.

The advertised commodity picture refers to the commodity picture set by the commodity dealer on the commodity page corresponding to the object.

It is understandable that the advertised commodity pictures corresponding to each object are stored in the advertisement database. Based on the object picture in the frame of the video obtained in S201, the feature information of the object picture can be extracted. The advertisement database can be searched, according to the feature information of the object picture, to look for the advertised commodity picture matched with the object. It should be noted that the matched advertised commodity picture may be an advertised commodity picture corresponding to the object, or an advertised commodity picture of a similar object. For example, the recognized object in the frame of the video is sunglasses. By matching the sunglasses with a corresponding advertised commodity picture in the advertisement database, the matched advertised commodity picture may be a sunglasses with exactly the same style, model and color as said sunglasses, or may be a sunglasses with the same style, but different models and different colors.

S203: generating a corresponding object advertisement data based on the advertised commodity picture.

The object advertisement data is used by the user to access a commodity page of the object corresponding to the object picture on the terminal.

According to some embodiments, after determining the advertised :commodity picture of the object in the advertisement database, a purchase link of the object can be queried according to the advertised commodity picture. The object can have multiple purchase channels, including official website and third party purchasing platforms such as Taobao, Jingdong, and Pinduoduo, so the user can get the purchase link of the object to the above multiple purchase channels. Further, the purchase link of the object corresponding to the object picture can be generated as a QR code, and the QR code can be added to any position on the object picture, and the object picture with the QR code added can be used as an object advertisement data. It is also possible to generate a QR code with the object picture embedded in, and use the QR code as an object advertisement data.

S204: pushing the object advertisement data to the terminal.

According to some embodiments, based on the object advertisement data generated in S203, during the video playing process, the object advertisement data is displayed on the video playing interface. One or more of object pictures can be recognized in a frame of the video. When one object picture is recognized, i.e. corresponding to one object, only the object advertisement data of the object need to be displayed on the video playing interface. When multiple object pictures are recognized, if the multiple object pictures correspond to a same object, only the object advertisement data of the object need to be displayed on the video playing interface; if the multiple object pictures correspond to multiple objects, and the object advertisement data of the multiple objects can be displayed in multiple different positions on the video playing interface.

When the embodiments of the present disclosure are executed, a server would determine an object picture in a frame of the video during a video playing process. Then, the server matches the object picture with a corresponding advertised commodity picture in an advertisement database and then generate a corresponding object advertisement data based on the advertised commodity picture, or recognize an object name based on the object picture, then obtain a corresponding object advertisement data according to the object name. And then the server pushes the object advertisement data to the terminal. According to methods of this disclosure, when the server pushes the object advertisement data corresponding to the object, the user can directly access the object's commodity page through the object advertisement data, and it is no longer necessary for the user to search on the official website or third-party service platform to access the object's commodity page, improving the accuracy of advertising and the user experience.

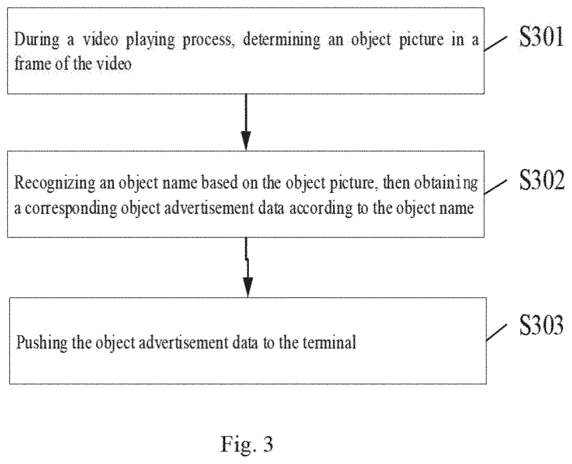

FIG. 3 is a schematic flowchart of an advertisement pushing method according to an embodiment of this disclosure. As shown in FIG. 3 the method of the embodiment of the present disclosure may include the following steps:

S301: during a video playing process, determining the object picture in the frame of the video.

It is understandable that a video is consisted of a plurality of pictures, and each picture can contain various objects. When the video is recognized, the pictures can be recognized through image recognition technology to obtain recognition results, the recognition results include various objects, such as: bags, glasses, clothes, hats, skin care products, cosmetics, microphones, etc. Based on the position of each object in the picture, a screenshot can be taken to generate object pictures in which objects are showed.

It is understandable that the video may be a TV drama type video, a variety show type video, an advertisement type video, and other types of videos, and so on,

S302: recognizing an object name based on the object picture, then obtaining a corresponding object advertisement data according to the object name.

The object name is used to identify different object pictures. The object advertisement data is used by the user to access the commodity page of the object corresponding to the object picture on the terminal.

According to some embodiments, for some objects in the frame of the video, these objects can be manually marked, and a corresponding object name is set for each object, and then the object name and the object advertisement data corresponding to the object are correlated, and the object advertisement data is also pre-generated. After determining the object picture, the server would recognize the object name corresponding to the object picture, and then may obtain the object advertisement data corresponding to the object name from the database based on the object name. It should be noted that the object advertisement data may be an object advertisement data corresponding to the object, or an object advertisement data of a similar object of the object. For example, the recognized object in the frame of the video is sunglasses, and the object name is ‘DIOR sunglasses’. When obtaining the object advertisement data of the object corresponding to ‘DIOR sunglasses’, the object advertisement data of sunglasses with exactly the same brand, style, model and color as ‘DIOR sunglasses’, or the object advertisement data of sunglasses with the same brand, style, but different models and colors can be obtained.

S303: pushing the object advertisement data to the terminal.

According to some embodiments, based on the object advertisement data obtained in S302, during the video playing process, the object advertisement data is displayed on the video playing interface. One or more of object pictures can be recognized in a frame of the video. When one object picture is recognized, i.e. corresponding to one object, only the object advertisement data of the object need to be displayed on the video playing interface. When multiple object pictures are recognized, if the multiple object pictures correspond to a same object, only the object advertisement data of the object need to be displayed on the video playing interface; if the multiple object pictures correspond to multiple objects, and the object advertisement data of the multiple objects can be displayed in multiple different positions on the video playing interface.

When the embodiments of the present disclosure are executed, a server during a video playing process would determine an object picture in a frame of the video and match the object picture with a corresponding advertised commodity picture in an advertisement database. And then the server generates a corresponding object advertisement data based on the advertised commodity picture, or recognize an object name based on the object picture, then obtain a corresponding object advertisement data according to the object name. And then the server pushes the object advertisement data to the terminal. With methods of this disclosure, when the server pushes the object advertisement data corresponding to the object, the user can directly access the object's commodity page through the object advertisement data, and it is no longer necessary for the user to search on the official website or third-party service platform to access the object's commodity page, improving the accuracy of advertising and the user experience.

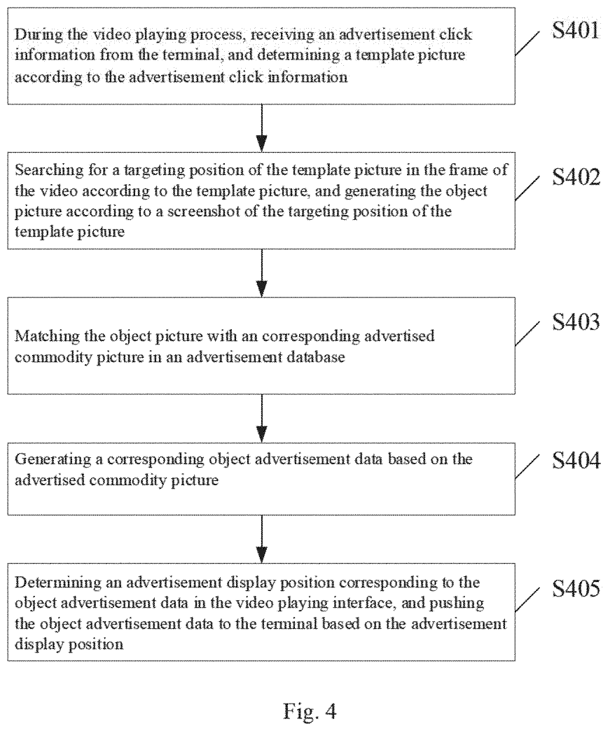

FIG. 4 is a schematic flowchart of an advertisement pushing method according to an embodiment of this disclosure. As shown in FIG. 4, the method of the embodiment of the present disclosure may include the following steps:

S401: during the video playing process, receiving an advertisement click information from the terminal, and determining a template picture according to the advertisement click information.

The advertisement click information includes the number and type of clicks on the commodity by a user within a preset time period. The template picture is used to recognize the object picture in the frame of the video.

It should be noted that the application scenario of embodiments of this disclosure is not only to push object advertisement data onto the terminal, but also to receive, after the user clicks on the object advertisement data, the click feedback data sent by the user's terminal to the server, i.e. the advertisement click information. When the server pushes the object advertisement data onto the terminal device, if the user is interested in. the object in the object advertisement data, the user will click on the object advertisement data to visit the object's commodity page. When the terminal recognizes that the user clicks on the object advertisement data to visit the object's commodity page, it will send an advertisement click information to the server. The advertisement click information is used to notify the server which object advertisement data the user clicked to access the commodity page corresponding to the object. The server will calculate the number of clicks on each object advertisement data within a preset time period (may be five minutes, ten minutes, etc.,) according to the received advertisement click information sent by the terminal, and determine the object with the number of clicks greater than a threshold to obtain the master page picture of the object on the commodity page, then the above master page picture can be used as the template picture.

For example, a frame of the video includes object A, object B and object C, and the video playing interface shows an object advertisement data A corresponding to object A, an object advertisement data B corresponding to object B, and an object advertisement data C corresponding to object C. The advertisement click information is shown in Table 2.1:

TABLE 2.1
The number of clicks on each object advertisement
data within 10 minutes

| | object | object | object |
|---|---|---|---|
| | advertisement | advertisement | advertisement |
| | data A | data B | data C |
| Uer: Mr. Li | 3 times | 1 times | 1 times |
| User: Mr. Wang | 1 times | 0 times | 3 times |
| User: Mr. Liu | 2 times | 0 times | 2 times |

As can be seen from Table 2.1, within 10 minutes, the user Mr. Li clicks the object advertisement data A three times, the object advertisement data B one time, and the object advertisement data C one time: the user Mr. Wang clicks the object advertisement data A one time and the object advertisement data C three times; the user Mr. Liu clicks the object advertisement data A two times and the object advertisement data C two times. Then, when the server receives the above advertisement click information, it can determine the template picture as the corresponding template picture of object A, object B, and object C.

S402: Searching for a targeting position of the template picture in the frame of the video according to the template picture, and generating the object picture according to a screenshot of the targeting position of the template picture.

The targeting position refers to a position of the object corresponding to the template picture in the frame of the video.

According to some embodiments, to determine the object picture in the frame of the video, the targeting position of the template picture can be searched in the frame of the video based on the template picture, that is, the position of the object corresponding to the template picture is found, and then the object picture is generated according to a screenshot of the position of the object corresponding to the template picture.

By way of example, taking the example in S301 again, the template picture corresponding to object A is template A, and the position of object A in the frame of the video is found according to template A, and then a screenshot operation is performed according to the position of object A, and the obtained screenshot has object A in it, and then this screenshot including object A can be called an object picture.

S403: matching the object picture with an corresponding advertised commodity picture in an advertisement database.

According to some embodiments, the advertisement database is preset with advertised commodity pictures of all objects in the video. When the corresponding advertised commodity pictures are matched in the advertisement database based on the object picture, the feature information of the object picture can be extracted, including color features and shape features and texture features. Based on the feature information of the object picture, the similarity between each advertised commodity picture in the advertisement database and the object picture is calculated, and the advertised commodity object picture with a similarity greater than of equal to a similarity threshold is taken as the advertised commodity picture matched with the object picture.

It is understandable that the object picture and the advertised commodity picture may be pictures of the same object, or pictures of similar objects. If the object picture and the advertised commodity picture are pictures of the same object, the advertised commodity picture can be matched according to the above similarity calculation method, wherein the similarity threshold can be set to 95%, and the advertised commodity picture (corresponding to a same type of object) with a similarity greater than 95% is taken as the matched advertised commodity picture. If the object picture and the advertised commodity picture are pictures of similar objects, the advertised commodity picture can be matched according to the above similarity calculation method, wherein the similarity threshold can be set to 85%, and the advertised commodity picture (corresponding to a same type of object) with a similarity greater than 85% is taken as the matched advertised commodity picture.

For example, the recognized object in the frame of the video is sunglasses; matching the sunglasses with a corresponding advertised commodity picture in the advertisement database, the matched advertised commodity picture may be sunglasses with exactly the same style, model and color as said sunglasses, or may be sunglasses with the same style, but different models and different colors.

S404: generating a corresponding object advertisement data based on the advertised commodity picture.

The object advertisement data includes the object picture and an object graphic code. The object graphic code may be a QR code by which the user could access the object's commodity page on the terminal.

According to sonic embodiments, in addition to the advertised commodity picture of the object, a purchase link information of the object may be present in the advertisement database. Therefore, a purchase link information corresponding to the advertised commodity picture can be queried in the advertisement database, and a QR code can be generated based on the purchase link information. The QR code can be added to the object picture or a billboard commodity to generate the corresponding object advertisement data, or a QR code with the object picture or the advertised commodity picture embedded in can be generated and taken as the object advertisement data.

According to some embodiments, a purchase link of the object can be queried according to the advertised commodity picture in third party purchasing platforms, such as Taobao, Jingdong, Pinduoduo and Vipshop. A QR code can be generated based on the purchase link information, and the QR code can be added to the object picture or the advertised commodity picture to generate the corresponding object advertisement data, or a QR code with the object picture or the advertised commodity picture embedded in can be generated and taken as the object advertisement data.

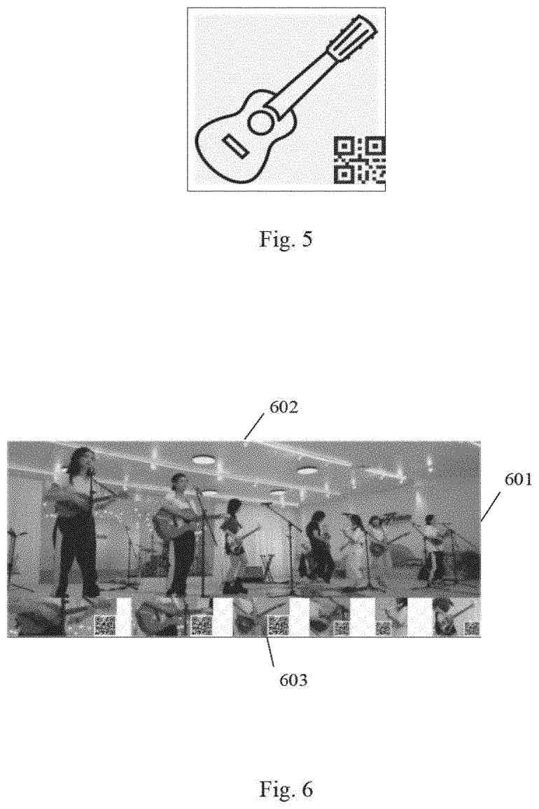

For example, the object advertisement data as shown in FIG. 5 can be generated. In FIG. 5, a guitar and a QR code picture are present, and the guitar is the object picture in the frame of the video, and the QR code picture is generated based on the purchase information of the guitar in the advertisement database and the purchase link information in the third-party service platform.

S405: determining an advertisement display position corresponding to the object advertisement data in the video playing in and pushing the object advertisement data to the terminal based on the at display position.

Wherein, advertisement display position is used to display the object advertisement data corresponding to the object in the video playing interface.

According to some embodiments, the advertisement display position may be a preset advertisement column position in the video playing interface. As shown in the schematic diagram of the playing interface of the terminal as shown in FIG. 6, 602 is the video playing interface on the video terminal, and 603 is the preset advertisement column position on the video playing interface, and 603 includes object advertisement data of multiple objects, and 601 is the display area of the frame of the video on the video playing interface, and the server pushes the object advertisement data to the terminal in the area indicated by 603.

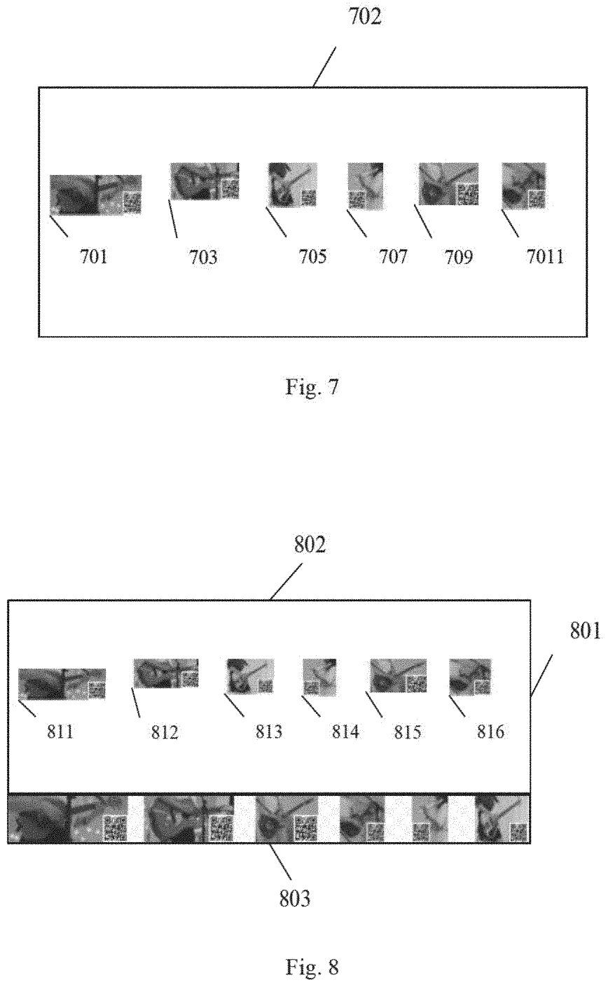

According to some embodiments, the advertisement display position can be determined according to the display position of the object in the frame of the video. The display position of the object can be determined first, and then the display position of the object advertisement data can be determined without blocking the object in the frame of the video. Referring to the schematic diagram of the display interface of the terminal as shown in FIG. 7, 702 is the display area of the frame of the video on the video playing interface, and 701, 703, 705, 707, 709 and 7011 are the display positions of the objects, and the object advertisement data is displayed near the display positions.

According to some embodiments, the advertisement display position may be a preset advertisement column position in the video playing interface. The advertisement display position can also be determined according to the display position of the object in the frame of the video. Referring to the display interface diagram of the terminal as shown in FIG. 8, 802 is the display area of the frame of the video on the video playing interface, and 801 is the display area of the frame of the video on the video playing interface, and 803 is the preset advertisement column position on the video playing interface, and 811, 812, 813, 814, 815, and 816 are vicinity of the positions of the objects on the video playing interface, and the server can push the advertisement data to the terminal based on positions indicated by 811-816 and the preset advertisement column position indicated by 803 simultaneously.

When the technical solutions of embodiments of the present disclosure are executed, a server during a video playing process would receive an advertisement click information from the terminal and determine a template picture, and search the targeting position of the template picture in the frame of the video, and generate an object picture based on the targeting position of the template picture; match the object picture with a corresponding advertised commodity picture in an advertisement database and then generate an object advertisement data, or recognize an object name based on the object picture, and obtain a corresponding object advertisement data according to the object name; and determine the advertisement display position corresponding to the object advertisement data; and push the object advertisement data to the terminal based on the advertisement display position. With methods of this disclosure, when the server pushes the object advertisement data corresponding to the object, the user can directly access the object's commodity page through the object advertisement data, and it is no longer necessary for the user to search on the official website or third-party service platform to access the object's commodity page, and the server can also push the advertisement data of objects that the user is interested in according to the users advertisement click information, improving the accuracy of advertising and the user experience.

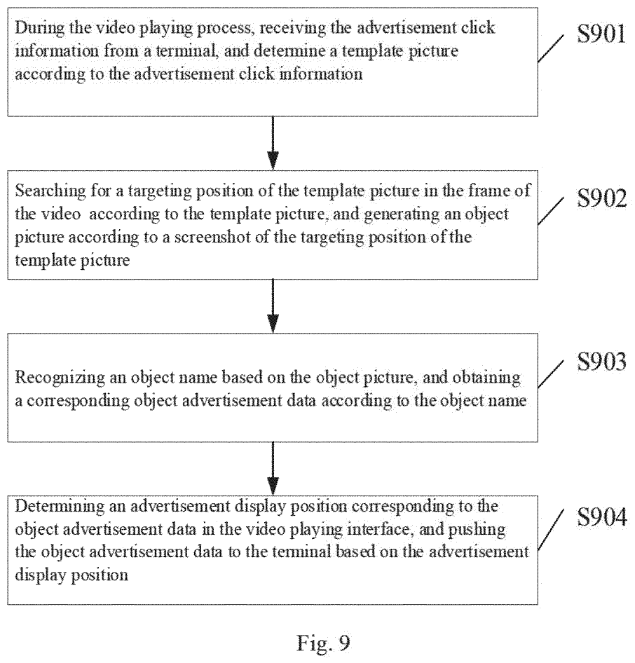

FIG. 9 is a schematic flowchart of an advertisement pushing method according to an embodiment of this disclosure. As shown in FIG. 9, the method of the embodiment of the present disclosure may include the following steps:

S901: during the video playing process, receiving the advertisement click information from a terminal, and determine a template picture according to the advertisement click information.

For details, please refer to S401 in FIG. 4, which not be repeated here.

S902: searching for a targeting position of the template picture in the frame of the video according to the template picture, and generating an object picture according to a screenshot of the targeting position of the template picture.

For details, please refer to S402 in FIG. 4, which not be repeated here.

S903: recognizing an object name based on the object picture, and obtaining a corresponding object advertisement data according to the object name.

The object name is used to identify different object pictures. The object advertisement data is used by the user to access the commodity page of the object corresponding to the object picture on the terminal.

According to some embodiments, for some objects in the frame of the video, these objects can be manually marked, and a corresponding object name is set for each object, and then the object name and the object advertisement data corresponding to the object are correlated, and the object advertisement data is also pre-generated. After determining the object picture, the server would recognize the object name corresponding to the object picture, and then may obtain the object advertisement data corresponding to the object name from the database based on the object name. It should be noted that the object advertisement data may be an object advertisement data corresponding to the object, or an object advertisement data of a similar object of the object.

For example the recognized object in the frame of the video is a sunglasses, and the object name is ‘DIOR sunglasses’. When obtaining the object advertisement data corresponding to ‘DIOR sunglasses’, the object advertisement data of sunglasses with exactly the same brand, style, model and color as ‘DIOR sunglasses’, or the object advertisement data of sunglasses with the same brand, style, but different models and colors can be obtained.

For another example, the recognized object picture in the frame of the video is a picture of a certain star. If it is a picture of Lin Yifei, the object name corresponding to the preset picture of Liu Yifei is ‘Tissot Watch Type A’. It is noted that the object name can be set according to the object that the advertiser wants to push during actual application.

When obtaining the object advertisement data corresponding to ‘Tissot Watch A’, the object advertisement data of watch with exactly the same brand, style, model and color as ‘Tissot Watch A’, or the object advertisement data of watch with the same brand, but different styles, different models and different colors.

S904: determining an advertisement display position corresponding to the object advertisement data in the video playing interface, and pushing the object advertisement data to the terminal based on the advertisement display position.

For details, please refer to S405 in FIG. 4, which will not be repeated here.

When the technical solutions of embodiments of the present disclosure are executed, a server during a video playing process would receive an advertisement click information from the terminal and determine a template picture, and search the targeting position of the template picture in the frame of the video, and generate an object picture based on the targeting position of the template picture: recognize an object name based on the object picture. and obtain a corresponding object advertisement data according to the object name, and determine the advertisement display position corresponding to the object advertisement data in the video playing interface, or recognize an object name based on the object picture, and obtain a corresponding object advertisement data according to the object name; and push the object advertisement data to the terminal based on the advertisement display position. With methods of this disclosure, when the server pushes the object advertisement data corresponding to the object, the user can directly access the object's commodity page through the object advertisement data, and it is no longer necessary for the user to search on the official website or third-party service platform to access the object's commodity page, and the server can also push the advertisement data of objects that the user is interested in according to the user's advertisement click information, improving the accuracy of advertising and the user experience.

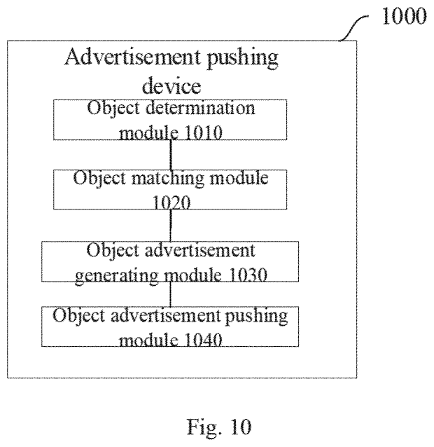

Now refer to FIG. 10, which is a schematic structural diagram of an advertisement pushing device according to an embodiment of this disclosure. The advertisement pushing device 1000 can be implemented as all or a part of the server through software, hardware or both. The device 1000 includes: an object determination module 1010 to determine an object picture in a frame of the video during a video playing process; an object matching module 1020 to match the object picture with a corresponding advertised commodity picture in an advertisement database; an object advertisement generating module 1030 to generate a corresponding object advertisement data based on the advertised commodity picture, and an object advertisement pushing module 1040 to push the object advertisement data to a terminal.

Optionally, the object determination module 1010 includes: a first unit to obtain a template picture; a second unit to search for a targeting position of the template picture in the frame of the video according to the template picture; and a third unit to generate an object picture according to a screenshot of the targeting position of the template picture.

Optionally, the object determination module 1010 further includes: a fourth unit to receive an advertisement click information from the terminal device; wherein, the advertisement click information includes the number and type of clicks on the commodity by a user within a preset time period; and a fifth unit to determine the template picture according to the advertisement click information.

Optionally, the object advertisement generating module 1030 includes: a first generating unit to query a purchase link information corresponding to the advertised commodity picture in the advertisement database, and generate a corresponding object advertisement data according to the object picture and the purchase link information; and/or a second generating unit to query a purchase link information corresponding to the advertised commodity picture in a third-party service platform, and generate a corresponding object advertisement data according to the object picture and the purchase link information.

Optionally, the object advertisement pushing module 1040 includes: a first pushing unit to determine the advertisement display position corresponding to the object advertisement data in the video playing interface; and a second pushing, unit to push the object advertisement data to the terminal based on the advertisement display position.

When the technical solutions of embodiments of this disclosure are executed, the server during a video playing process would determine the object picture in the frame of the video, and then match the object picture with an advertised commodity picture in the advertisement database. and then generate a corresponding object advertisement data based on the advertised commodity picture, and push the object advertisement data to the terminal. With methods of this disclosure, when the server pushes the object advertisement data corresponding to the object, the user can directly access the object's commodity page through the object advertisement data, and it is no longer necessary for the user to search on the official website or third-party service platform to access the object's commodity page, improving the accuracy of advertising and the user experience.

The embodiment of the present application also provides a computer storage medium. The computer storage medium may store a plurality of instructions, and the instructions are suitable for being loaded by a processor and executing the above method steps. The specific execution process can e seen in FIG. 2. The detailed description of the embodiment shown in FIG. 3, FIG. 4 and FIG. 9 will not be repeated here.

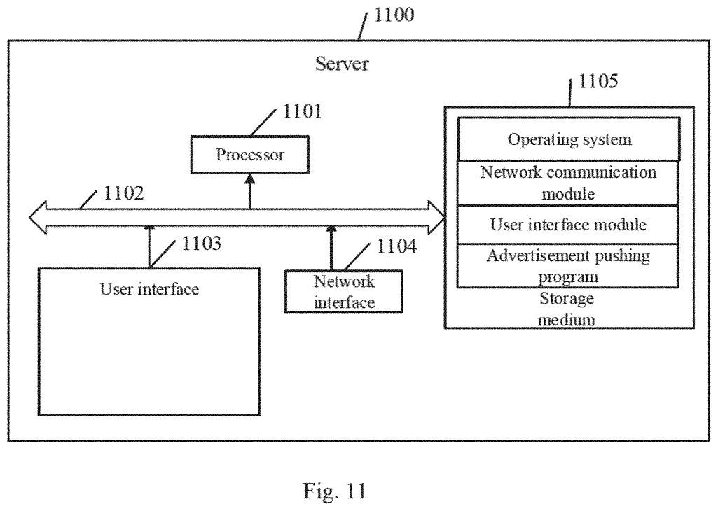

Further, FIG. 11 provides a schematic structural diagram of a server (terminal) according to an embodiment of this application. As shown in FIG. 11 the server 1100 may include: at least one processor 1101, at least one network interface 1104, a user interface 1103, a memory 1105, and at least one communication bus 1102.

Among them, the communication bus 1102 is used to implement connection and communication between these components.

The user interface 1103 may include, and the optional user interface 1103 may also include a standard wired interface and a wireless interface.

Among them, the network interface 1104 may optionally include a standard wired interface and a wireless interface (such as a WI-FI interface).

The processor 1101 may include one or more processing cores. The processor 1101 uses various excuses and lines to connect various parts of the entire server 1100, and executes the server by running or executing instructions, programs, code sets, or instruction sets stored in the memory 1105, and calling data stored in the memory 1105, 1100's various functions and processing data. Optionally, the processor 1101 may use at least one of Digital Signal Processing (DSP), Field-Programmable Gate Array (FPGA), and Programmable Logic Array (PLA) A kind of hardware form to realize. The processor 1101 may be integrated with one or a combination of a central processing unit (Central Processing Unit, CPU), a graphics processor (Graphics Processing Unit, GPU), a modem, and the like. Among them, the CPU mainly processes the operating system, user interface, and application programs; the GPU is used to render and draw the content that the display needs to display; the modem is used to process wireless communication. It is understandable that the above-mentioned modem may not be integrated into the processor 1101, but may be implemented by a chip alone.

The memory 1105 may include random access memory (Random Access Memory, RAM), or may include read-only memory (Read-Only Memory). Optionally, the memory 1105 includes a non-transitory computer-readable storage medium (non-transitory computer-readable storage medium). The memory 1105 may be used to store instructions, programs, codes, code sets or instruction sets. The memory 1105 may include a program storage area and a data storage area, where the program storage area may store instructions for implementing the operating system and instructions for at least one function (such as touch function, sound playback function, image playback function, etc), Instructions used to implement the foregoing method embodiments, etc.: the storage data area can store the data involved in the foregoing method embodiments, etc. Optionally, the memory 1105 may also be at least one storage device located far away from the foregoing processor 1101. As shown in FIG. 11, the memory 1105 as a computer storage medium may include an operating system, a network communication module, a user interface module, and an advertisement pushing program.

In the server 1100 shown in FIG. 11, the user interface 1103 is mainly used to provide an input interface for the user to obtain the data input by the user; and the processor 1101 can be used to call the advertisement push program stored in the memory 1105, and specifically execute the following operating: during a video playing process, determining an object picture in a frame of the video; matching the object picture with an corresponding advertised commodity picture in an advertisement database: generating a corresponding object advertisement data based on the advertised commodity picture; or recognizing an object name based on the object picture, then obtaining a corresponding object advertisement data according to the object name; pushing the object advertisement data to the terminal.

The articles “a”, “an”, “the”, “this”, “that” as used in this application and the appended claims should generally be construed to mean “one or more” unless specified otherwise or clear from context to be directed to a singular form.

In the embodiments provided in this disclosure, it should be understood that the disclosed device and method may be implemented in other ways. For example, the device embodiments described above are only illustrative. For example, the partitioning of modules is only a logical function partitioning, and there may be other kind of partitioning in actual implementation, e.g., multiple modules or components can be combined or integrated into another system, or some features can be ignored or not implemented. In addition, the displayed or discussed mutual coupling or direct coupling or communication connection may be indirect coupling or communication connection through some interfaces, devices or modules, and may be in electrical, mechanical or other forms.

The modules described as separate components may or may not be physically separate, and the components displayed as modules may or may not be physical modules, that is, they may be located in one place, or they may be distributed on multiple network modules. Some or all of the modules may be selected according to actual needs to achieve the purposes of the technical solutions of the embodiments.

In addition, each functional module in each embodiment of the present disclosure may be integrated into one processing module, or each module may be physically present individually, or two or more modules may be integrated into one module. The aforementioned integrated module can be implemented in the fair of hardware or software functional modules.

If the integrated module is implemented in the firm of a software function module and sold or used as an independent product, it can be stored in a computer readable storage medium. Based on this understanding, the technical solution of this disclosure essentially, or the part that contributes to the existing technology, or all or part of the technical solution can be embodied in the form of a software product, and the computer software product is stored in a storage medium, including several instructions to make a computer device (which can be a personal computer, a server, or a network device, etc.) execute all or part of the steps in the methods of various embodiments of the present application. The aforementioned storage media include: U disk, mobile hard disk, read-only memory (ROM, Read-Only Memory), random access memory (RAM, Random Access Memory), magnetic disk or optical disk and other media that can store program code.

It should be noted that regarding the aforementioned method embodiments, for simplicity of description, they are all expressed as a series of step combinations, but those skilled in the art. should know that this disclosure is Rot limited by the described sequence of steps. Because according to this disclosure, some steps can be performed in other sequence or simultaneously. Secondly, those skilled in the art should also know that the embodiments described in the specification are all preferred embodiments, and the involved steps and modules are not necessarily all required by this disclosure.

In the aforementioned embodiments, the description of each embodiment has its own emphasis. For a part that is not detailed in an embodiment, reference may be made to related descriptions of other embodiments.

This disclosure provides the description of an method, a device, a storage medium and a terminal for pushing advertisement above. For those skilled in the art, according to the spirits of embodiments of this application, modifications may be possible in the implementations and application scope. In summary, the content of this specification should not be construed as a limitation to this disclosure.

What is claimed is:

1. An advertisement pushing method, wherein the method comprises:
during a video playing process, determining an object picture in a fame of the video;
matching the object picture with corresponding advertised commodity picture in an advertisement database;
generating a corresponding object advertisement data based on the advertised commodity picture; or recognizing an object name based on the object picture, then obtaining a corresponding object advertisement data according to the object name; and
pushing the object advertisement data to the terminal.

2. The method of claim 1, wherein said ‘determining an object picture in a frame of the video’ comprises:
obtaining a template picture;
searching for a targeting position of the template picture in the video playing picture based on the template picture; and
generating the object picture according to a screenshot of the targeting position o the template picture.

3. The method of claim 2, wherein before said ‘obtaining a template picture’, the method further comprises:
receiving an advertisement click information from the terminal, wherein the advertisement click information includes the number and type of clicks on the commodity by a user within a preset time period; and
determining the template picture according to the advertisement click information.

4. The method of claim 1, wherein said ‘generating a corresponding object advertisement data based on the advertised commodity picture’ comprises:
querying, in the advertisement database, a purchase link information corresponding to the advertised commodity picture, and generating a corresponding object advertisement data according to the object picture and the purchase link information; and/or
querying, in a third-party service platform, a purchase link information corresponding to the advertised commodity picture, and generating a corresp6nding object advertisement data according to the object picture and the purchase link information.

5. The method of claim 1, wherein said ‘generating a corresponding object advertisement data based on the advertised commodity picture’ comprises:
querying a purchase link information corresponding to the advertised commodity picture in the advertisement database, and generating a corresponding object advertisement data according to the advertised commodity picture and the purchase link information; and/or
querying a purchase link information corresponding to the advertised commodity picture in a third-party service platform, and generating a corresponding object advertisement data according to the advertised commodity picture and the purchase link information.

6. The method of claim 1, wherein said ‘pushing the object advertisement data to the terminal’ comprises:
determining an advertisement display position corresponding to the object advertisement data in a video playing interface; and
pushing the object advertisement data to the terminal based on the advertisement display position.

7. The method of claim 6, wherein the advertisement display position is a preset advertisement column position in the video playing interface; and/or
the advertisement display position is determined by a display position of the object in the frame of the video.

8. The method of claim 1, wherein tie object advertisement data comprises the object picture and an object graphic code; or
the object advertisement data comprises the advertised commodity picture and an object graphic code; wherein the object graphic code is used to access a commodity page of the object picture on the terminal.

9. An advertisement pushing device, wherein the device comprises:
an object determination module configured to, during a video playing process, determine an object picture in a frame of the video;
an object matching module configured to match the object picture with a corresponding advertised commodity picture in an advertisement database;
an object advertisement generating module configured to generate a corresponding object advertisement data based on the advertised commodity picture; or
an object advertisement obtaining module configured to recognize an object name based on the object picture, and to obtain corresponding object advertisement data according to the object name; and
an object advertisement pushing module configured to push the object advertisement data to a terminal.

10. A non-transitory storage medium, wherein the non-transitory storage medium stores a plurality of instructions suitable for being loaded by a processor and executing the method of claim 1.

11. A terminal, comprising: a processor and a non-transitory memory; wherein the non-transitory memory stores a computer program suitable for being loaded by the processor and executing the method of claim 1.
